(19) United States
(12) Patent Application Publication
(10) Pub. No.: US 2025/0150851 A1
(43) Pub. Date: May 8, 2025

(54) METHOD AND APPARATUS FOR MANAGING CONTROL PLANE CONFIGURATION IN WIRELESS COMMUNICATION SYSTEM

(71) Applicant: SAMSUNG ELECTRONICS CO., LTD., Suwon-si (KR)

(72) Inventors: Jan KIENIG, Warsaw (PL); Szymon STEFANSKI, Warsaw (PL); Gracjan KWIATKOWSKI, Warsaw (PL)

(73) Assignee: SAMSUNG ELECTRONICS CO., LTD., Suwon-si (KR)

(21) Appl. No.: 18/800,529

(22) Filed: Aug. 12, 2024

(30) Foreign Application Priority Data
Nov. 7, 2023 (KR) 10-2023-0152381
Nov. 13, 2023 (KR) 10-2023-0156364

(51) Int. Cl. H04W 24/02; H04W 48/18; H04W 60/04

(52) U.S. Cl. CPC H04W 24/02; H04W 48/18; H04W 60/04

(57) ABSTRACT

A method by a core network entity in a wireless communication system includes receiving, from an access and mobility management function (AMF), a request for a control plane configuration for a user equipment (UE), generating the control plane configuration for the UE based on the received request for the control plane configuration, and transmitting, to the AMF, the generated control plane configuration.

### CROSS-REFERENCE TO RELATED APPLICATIONS

This application claims benefit of priority under 35 U.S.C. § 119 to Korean Patent Application No. 10-2023-0152381, filed on Nov. 7, 2023, and Korean Patent Application No. 10-2023-0156364, filed on Nov. 13, 2023, in the Korean Intellectual Property Office, the disclosures of which are incorporated by reference herein in their entireties.

### BACKGROUND

### 1. Field

This disclosure relates to a method and an apparatus for managing a control plane configuration in a wireless communication system.

### 2. Description of Related Art

A 5th generation (5G) system architecture developed in a 3rd Generation Partnership Project (3GPP) defines functional division into components referred to as managed functions (MFs), as described in 3GPP Technical Specification (TS) 28.541, version 18.2.1, Jan. 13, 2023. An MF indicates a functional application running within virtual network functions (VNFs)/physical network functions (PNFs)/cloud naive network functions (CNFs). MFs perform a defined set of functions, as described in 3GPP TS 28.501 and related documents, and communicate with each other through standardized interfaces referred to as reference points.

Generating a network slice refers to spawning new instances of slice-dedicated MFs, and reusing MFs which may be shared between multiple slices. The slice-dedicated MFs may include, for example, a user plane function (UPF) and a session management function (SMF). Shared MFs may include, for example, an access and mobility management function (AMF), a network slicing selection function (NSSF), a unified data management (UDM), a network repository function (NRF), and the like.

The organization of slices, including determination about spawning new MF instances or reusing existing ones, is the role of a management and orchestration (MANO) layer of a 5G system.

According to the existing 3GPP system, a single UE may connect to a maximum of eight network slices (e.g., network slice instances (NSIs)) at the same time. Each of these network slices may have a different type (e.g., enhanced mobility broadband (eMBB), ultra reliable low latency communications (URLLC), mobile Internet of Things (mIoT), vehicle-to-everything (V2X), or the like), and each type may have a different requirement. While different functional and user plane (UP) requirements (e.g., throughput, latency, or the like) for each simultaneously connected network slice may be ensured using recent technologies, a radio access network (RAN) may have only a single control plane (CP) configuration.

Control plane setups may be set by an AMF based on a UE's request according to policies, however, current standards and technology may not provide a method for generating an accurate configuration. The basic approach assumes some predefined policies in the AMF.

When a UE is simultaneously connected to NSIs having different requirements for a control plane (e.g., different paging configurations due to different expected UE mobility patterns in different slices), this may result in selection of a sub-optimal configuration that may affect NSI performance. In addition, since there is a trade-off between resource consumption (some setups may consume more radio resources or a battery) and performance (some setups may provide better performance only for specific cases), there may not be a single best CP configuration which may be applied for a certain slice type.

For example, when a UE is simultaneously connected to a fixed wireless access (FWA) eMBB slice and a V2X slice, the FWA eMBB slice assumes that there is little or no UE mobility, and CP setups are required to reflect the same (a relaxed mobility configuration and a small paging radius). The V2X slice assumes high UE mobility which may be mapped to an optimal CP setup such as aggressive mobility and a large paging radius. Selecting an optimal CP setup for the FWA eMBB slice may result in affecting V2X slice performance. In this case, a CP setup for the V2X slice is required to be used since the CP setup for the V2X slice satisfies all of requirements of slices while sacrificing radio resources and battery life.

### SUMMARY

One or more example embodiments of the present disclosure provide a method and an apparatus capable of generating a CP setup in consideration of requirements for a plurality of network slices to which a UE is simultaneously connected.

According to an aspect of the present disclosure, a method by a core network entity in a wireless communication system includes receiving, from an access and mobility management function (AMF), a request for a control plane configuration for a user equipment (UE), generating the control plane configuration for the UE based on the received request for the control plane configuration, and transmitting, to the AMF, the generated control plane configuration.

According to an aspect of the present disclosure, an apparatus of a core network entity in a wireless communication system includes, at least one processor, and memory storing instructions. The instructions, when executed by the at least one processor individually or collectively, cause the apparatus to receive, from an AMF, a request for a control plane configuration for a UE, generate the control plane configuration for the UE based on the received request for the control plane configuration, and transmit, to the AMF, the generated control plane configuration to the AMF.

According to an aspect of the present disclosure, a non-transitory computer readable storage medium includes computer-executable instructions which, when executed by a processor of an apparatus of a core network entity in a wireless communication system, cause the apparatus to receive, from an AMF, a request for a control plane configuration for a UE, generate the control plane configuration for the UE based on the received request for the control plane configuration, and transmit, to the AMF, the generated control plane configuration.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates a structure of an exemplary communication system, according to an embodiment;

FIG. 2 illustrates user plane and control plane communications in an exemplary communication system, according to an embodiment;

FIG. 3 illustrates an operation of a core network entity for generating a control plane configuration, according to an embodiment;

FIGS. 4A to 4F illustrate deployments of a control plane configuration generation function (CPCGF), according to an embodiment;

FIG. 5 is a flowchart illustrating operations of network entities for generating a control plane configuration, according to an embodiment;

FIG. 6 is a flowchart illustrating operations of network entities for generating a control plane configuration, according to an embodiment;

FIG. 7 is a flowchart illustrating operations of network entities for generating a control plane configuration, according to an embodiment;

FIG. 8 is a flowchart illustrating operations of network entities for generating a control plane configuration, according to an embodiment;

FIG. 9 is a flowchart illustrating operations of a CPCGF, according to an embodiment;

FIG. 10 is a flowchart illustrating operations of a CPCGF for generating a control plane configuration, according to an embodiment; and FIG. 11 is a block diagram of an apparatus, according to an embodiment.

### DETAILED DESCRIPTION

Hereinafter, the operation principle of exemplary embodiments of the disclosure is described with reference to the accompanying drawings. The same or like elements illustrated in the drawings are designated by the same or like reference numerals as much as possible even though they are illustrated in different drawings. In the following description of the disclosure, detailed descriptions of known functions or configurations incorporated herein may be omitted when it is determined that the descriptions may make the subject matter of the disclosure unnecessarily unclear. The terms which are described below are terms defined in consideration of the functions in the disclosure, and may be different according to users, intentions of the users, or customs. Therefore, the definitions of the terms should be made based on the contents throughout the present disclosure.

Various changes and modifications may be made to the disclosure, and the disclosure may have various embodiments, some of which may be described with reference to the accompanying drawings. However, it should be appreciated that they are not intended to limit the disclosure to particular embodiments and the disclosure includes all changes, equivalents, or alternatives falling within the sprit and scope of the disclosure.

As used herein, it is to be understood that the singular expressions “a”, “an”, and “the” include plural expressions unless the context clearly indicates otherwise.

As used herein, the terms including an ordinal number, such as expressions “a first” and “a second”, may be used to describe various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure. The term “and/or” includes a combination or any one of a plurality of relevant items enumerated.

The terms as used herein are used merely to describe specific embodiments and are not intended to limit the disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

As used in embodiments of the disclosure, unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in embodiments of the disclosure.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

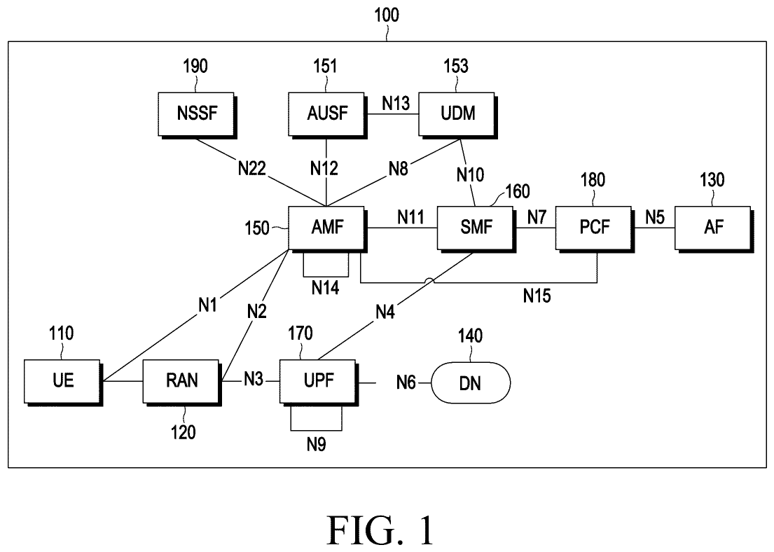

FIG. 1 illustrates a structure of an exemplary communication system, according to an embodiment.

A communication system 100 described in FIG. 1 may be a 5th generation (5G) communication system that may conform to a telecommunication standard (e.g., a 3rd Generation Partnership Project (3GPP) standard). A 5G mobile communication network includes a 5G user equipment (UE) 110 (e.g., a terminal), a 5G radio access network (RAN) 120 (e.g., a base station, a 5G nodeB (gNB), an evolved nodeB (eNB), or the like), and a 5G core network. The 5G core network includes network functions such as, but not limited to, an access and mobility management function (AMF) 150 of providing a mobility management function of a UE, a session management function (SMF) 160 of providing a session management function, a user plane function (UPF) 170 of performing a data transfer role, a policy control function (PCF) 180 of providing a policy control function, a unified data management (UDM) 153 of providing a management function of data such as, but not limited to, subscriber data and policy control data, and a unified data repository (UDR) of storing data of various network functions such as, but not limited to, the UDM 153.

In a 3GPP system, a conceptual link for connecting NFs in the 5G system is defined as a reference point. The description of reference points included in the 5G system architecture expressed in FIG. 1 is as follows.
N1: Reference point between UE 110 and AMF 150
N2: Reference point between (R) AN 120 and AMF 150
N3: Reference point between (R) AN 120 and UPF 170
N4: Reference point between SMF 160 and UPF 170
N5: Reference point between PCF 180 and application function (AF) 130
N6: Reference point between UPF 170 and data network (DN) 140
N7: Reference point between SMF 160 and PCF 180
N8: Reference point between UDM 153 and AMF 150
N9: Reference point between two core UPFs 170
N10: Reference point between UDM 153 and SMF 160
N11: Reference point between AMF 150 and SMF 160
N12: Reference point between AMF 150 and authentication server function (AUSF) 151
N13: Reference point between UDM 153 and AUSF 151
N14: Reference point between two AMFs 150
N15: Reference point between PCF 180 and AMF 150 for non-roaming scenario, and reference point between PCF 180 and AMF 150 within visited network for roaming scenario
N22: Reference point between AMF 150 and network slice selection function (NSSF) 190

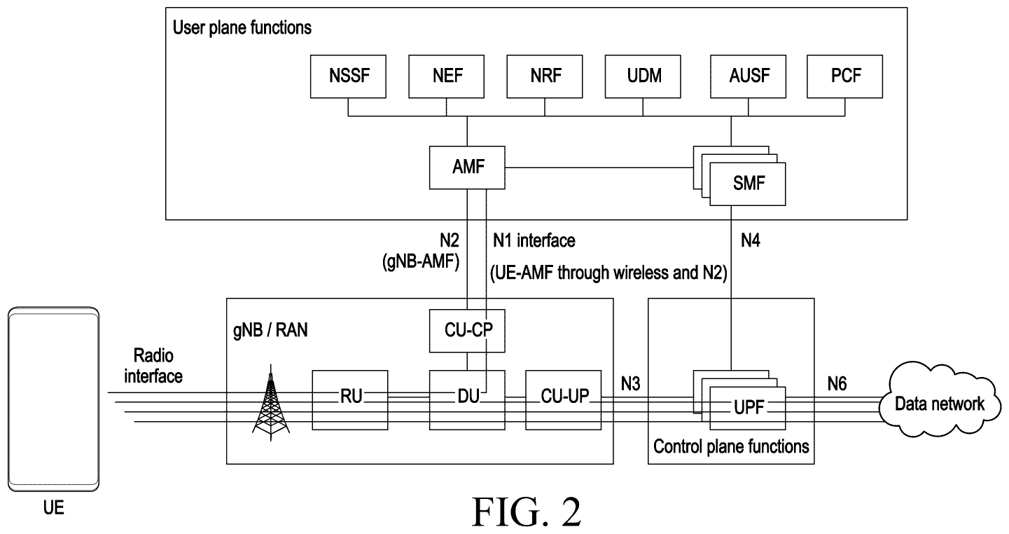

FIG. 2 illustrates user plane and control plane communications in an exemplary communication system, according to an embodiment.

Communications in a communication system may include a communication in a user plane (UP) and a communication in a control plane (CP). The communication in the UP may be used to transfer user data. The communication in the CP may be used to transfer signaling traffic.

In the UP, user data may be transferred between a UE and a data network through a radio unit (RU), a distributed unit (DU), and central unit-user plane (CU-UP) and user plane functions within a base station (e.g., a gNB or a RAN).

In the CP, signaling may be transferred between the UE and control plane functions through the RU, the DU, and the central unit-control plane (CU-CP) within the base station.

Regarding network slicing, the configuration and performance of the UP may be defined for each slice. This is because each network slice is logically separated from fixed parts of the network and a radio interface.

However, a CP configuration (such as, but not limited to, a paging configuration, a mobility configuration, or registration information) requires a single configuration for all slices. This is because, at a certain given moment, there is only one logical control plane connection in a radio interface and an N1 logical interface.

In the present disclosure, a control plane configuration/setup may include the following.
Parameters initially set in an AMF
Parameters set in registration and UE configuration procedures, UE-specific, and provided from an AMF to an RAN
Parameters set in registration and UE configuration procedures and transferred from an AMF to a UE

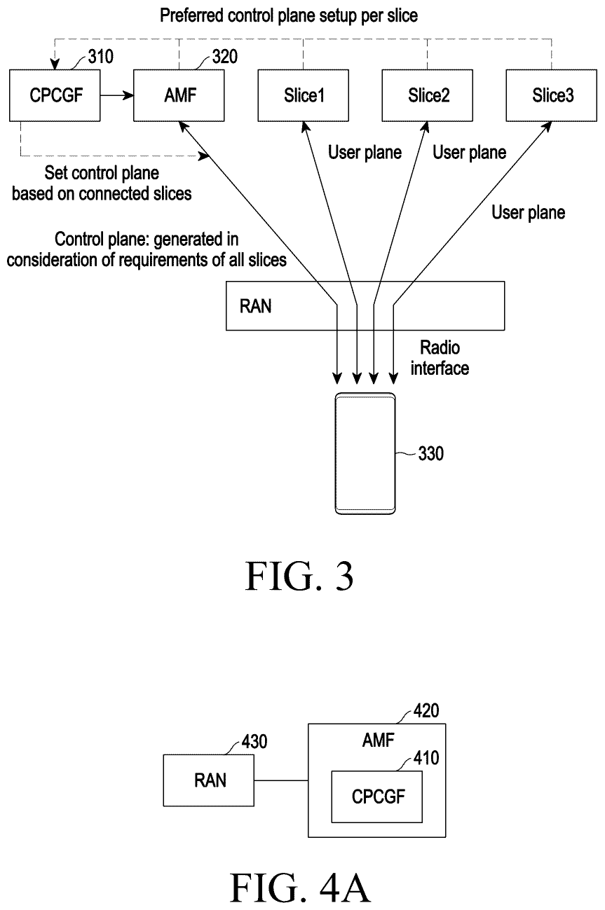

FIG. 3 illustrates an operation of a core network entity for generating a control plane configuration, according to an embodiment.

According to an embodiment, a wireless communication system may include a core network entity for generating a control plane configuration. The core network entity may be referred to as a control plane configuration generation function (CPCGF) 310, but the name of the core network entity is not necessarily limited thereto and may be simply referred to as a core network entity.

The CPCGF 310 may derive a CP configuration/setup in consideration of requirements of all network slices to which a UE is currently connected. The CPCGF 310 may generate a CP configuration/setup in consideration of requirements of all related slices instead of applying existing single hardcoded setups. CP setups generated by the CPCGF 310 may be transferred to the UE 330 or an RAN during initial registration, mobility registration, and UE configuration update procedures. These CP setups may be derived by analyzing a configuration preferred by each NSI to which the UE 330 is connected. Some of the CP setups generated by the CPCGF 310 are not provided to the UE 330 and may instead be stored in an AMF 320.

In addition to a function of generating a CP configuration, the CPCGF 310 may also function as a storage for a preferred control plane configuration for each slice. The CPCGF 310 may also function as a database for a tracking area.

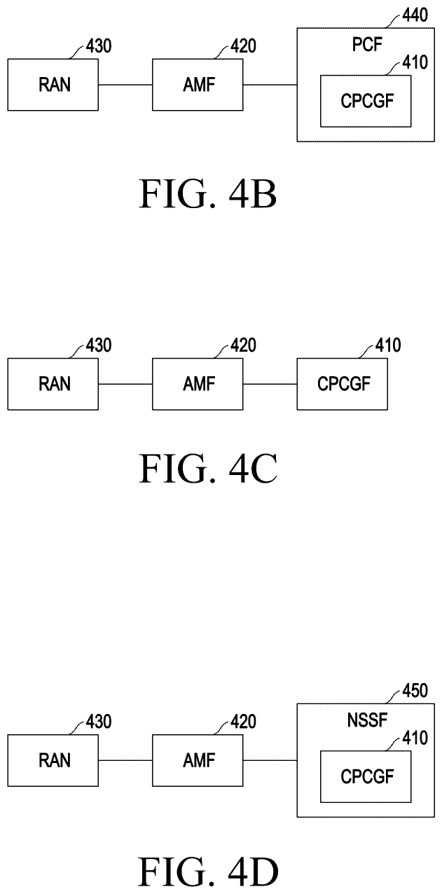

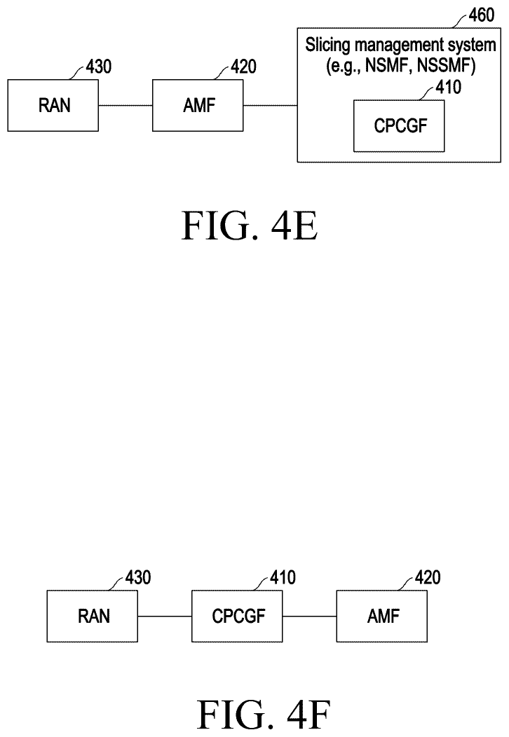

FIGS. 4A to 4F illustrate deployments of a CPCGF, according to embodiments of the present disclosure.

According to an embodiment, as shown in FIG. 4A, a CPCGF 410 may be implemented within an AMF 420.

According to an embodiment, as shown in FIG. 4B, the CPCGF 410 may be implemented within a PCF 440.

According to an embodiment, as shown in FIG. 4C, the CPCGF 410 may be implemented as a separate core network entity and connected to the AMF 420.

According to an embodiment, as shown in FIG. 4D, the CPCGF 410 may be implemented within an NSSF 450.

According to an embodiment, as shown in FIG. 4E, the CPCGF 410 may be implemented within a slicing management system 460 (e.g., a network slice management function (NSMF) or a network slice subnet management function (NSSMF)).

According to an embodiment, as shown in FIG. 4F, the CPCGF 410 may be implemented as a separate core network entity and disposed between an RAN 430 and the AMF 420.

In some embodiments, the CPCGF may be implemented within a UDR, a UDM, or an NRF.

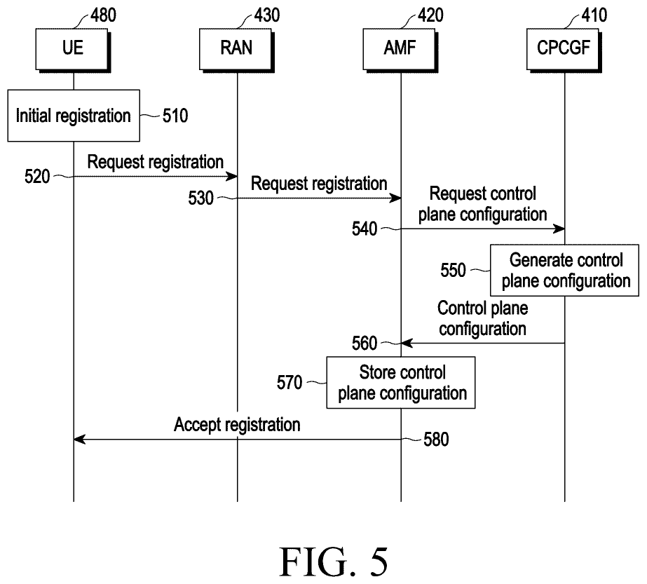

FIG. 5 is a flowchart illustrating operations of network entities for generating a control plane configuration, according to an embodiment.

A UE 480 may determine to perform an initial registration (510) and transmit a registration request message to the RAN 430. The registration request message may include requested network slice selection assistance information (NSSAI). The requested NSSAI may indicate at least one network slice to which the UE requests to connect.

The NSSAI may include a list of at least one single-NSSAI (S-NSSAI). The S-NSSAI may include a slice/service type (SST) which defines a general slice type and a slice differentiator (SD) for additionally distinguishing slices.

When the RAN 430 receives the registration request message from the UE 480, the RAN 430 may transfer the registration request message to the AMF 420 (530). That is, the registration request message from the UE 480 may be transmitted to the AMF 420 via the RAN 430.

Based on receiving a registration request, the AMF 420 may transmit a control plane configuration request to the CPCGF 410 (540). The control plane configuration request may include the requested NSSAI.

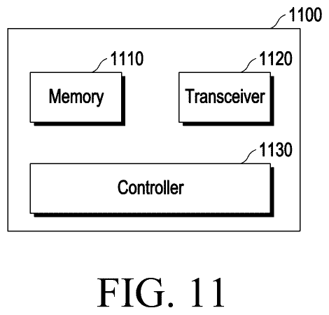

The CPCGF 410 may generate a control plane configuration, based on receiving the control plane configuration request from the AMF 420 (550). The CPCGF 410 may perform matching of PCPCs to generate the control plane configuration, and determine a plurality of parameters for the control plane configuration, based on at least one PCPC identified through the matching. A method for generating a control plane configuration by the CPCGF 410 is described with reference to FIG. 10.

The CPCGF 410 may transmit the generated control plane configuration to an AMF 420 in response to the control plane configuration request (560).

The AMF 420 may store the received control plane configuration (570).

The AMF 420 may transmit a registration acceptance message to the UE 480 through the RAN 430 (580). The registration acceptance message may include the control plane configuration received from the CPCGF 410.

The registration acceptance message may include allowed NSSAI. The allowed NSSAI may include a list of slices (e.g., a list of pieces of S-NSSAI) to which the UE is allowed to connect.

The registration acceptance message may include information related to registration and the plurality of parameters.

The UE 480 may store the control plane configuration included in the registration acceptance message.

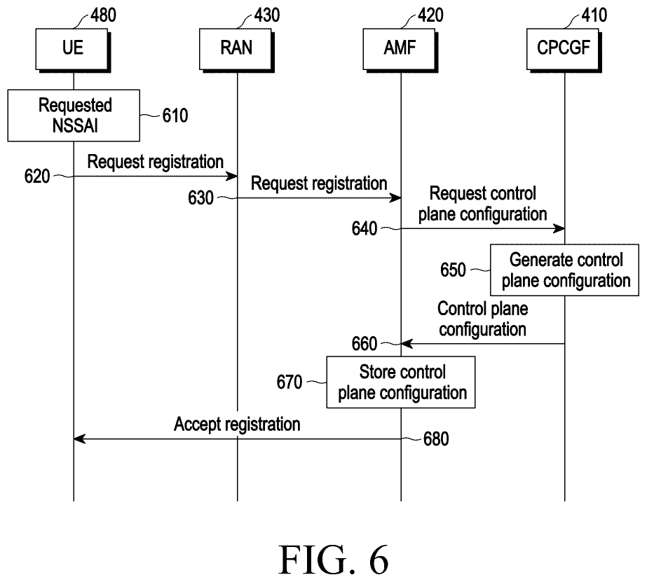

FIG. 6 is a flowchart illustrating operations of network entities for generating a control plane configuration, according to an embodiment.

The UE 480 may determine to change a requested NSSAI in a state of being registered in a network (610). The requested NSSAI change may include adding or deleting at least one NSSAI with respect to the NSSAI.

In a state where the UE 480 has been already registered, when the UE 480 determines to change the requested NSSAI, a mobility update procedure may be performed. The mobility update procedure may be executed even when the UE 480 changes a tracking area and a control plane configuration. Preferred control plane configurations (PCPCs) may be defined for each tracking area code list.

A PCPC may include a list of policies or CP setups which indicate optimal CP setups for a given slice instance or slice type. The PCPC may include a list of preferred CP parameters. The list of preferred CP parameters may include at least one of a list of all or a part of CP parameters, parameters including priorities or weights used to resolve conflicts, parameters including an allowed range or list of allowed values, parameters for formulas or procedures for deriving a preferred parameter based on a current state within the network, and parameters for formulas or procedures for generating a preferred parameter based on input parameters (e.g., a procedure for generation of a registration area based on a current tracking area reported by the UE).

The PCPC may include matching information. The matching information may be used to match the PCPC with a slice list requested from the UE. The PCPC matching information may include additional information unrelated to a slice, as an additional matching reference. The matching information may be defined in at least one of the following manner.
Matching per specific network slice instance (identified by an NSI ID)
Matching per specific network slice subnet instance (identified by an NSI ID)
Matching by an SST and/or an SD
Matching per slice characteristic obtained from a slicing management system (slice characteristics include at least one of service profile (ServiceProfile) or slice profile (SliceProfile) attributes, a network slice subnet type (networkSliceSubnetType), and a priority label (priorityLabel))
Matching per UE identifier or UE group
Matching per location defined in a list of tracking area codes

It may be possible to combine definitions of a PCPC and have a plurality of PCPCs for a single NSI or slice type. For example, a PCPC may be defined for an SST/SD and a specific UE. As another example, a plurality of PCPCs may be defined for the same SST/SD with respect to different locations (e.g., PCPC1: SST/SD1, TAC list=X,Y,X; PCPC2: SST1/SD1, TAC list=P,Q,X).

The UE 480 may transmit a registration request message to the RAN 430, based on determining to change the requested NSSAI (e.g., according to a mobility update procedure) (620). The registration request message may include the requested NSSAI. The requested NSSAI may be changed requested NSSAI.

When the RAN 430 receives the registration request message from the UE 480, the RAN 430 may transfer the registration request message to the AMF 420 (630). That is, the registration request message from the UE 480 may be transmitted to the AMF 420 via the RAN 430.

Based on receiving a registration request, the AMF 420 may transmit a control plane configuration request to the CPCGF 410 (640). The control plane configuration request may include the requested NSSAI.

The CPCGF 410 may generate a control plane configuration, based on receiving the control plane configuration request from the AMF 420 (650). The CPCGF 410 may perform matching of PCPCs to generate the control plane configuration, and determine a plurality of parameters for the control plane configuration, based on at least one PCPC identified through the matching. A method for generating a control plane configuration by the CPCGF 410 is described with reference to FIG. 10.

The CPCGF 410 may transmit the generated control plane configuration to the AMF 420 in response to the control plane configuration request (660).

The AMF 420 may store the received control plane configuration (670).

The AMF 420 may transmit a registration acceptance message to the UE 480 through the RAN 430 (680). The registration acceptance message may include the control plane configuration received from the CPCGF 410.

The registration acceptance message may include allowed NSSAI. The allowed NSSAI may include a list of slices (e.g., a list of pieces of S-NSSAI) to which the UE is allowed to connect.

The registration acceptance message may include information related to registration and the plurality of parameters.

The UE 480 may store the control plane configuration included in the registration acceptance message.

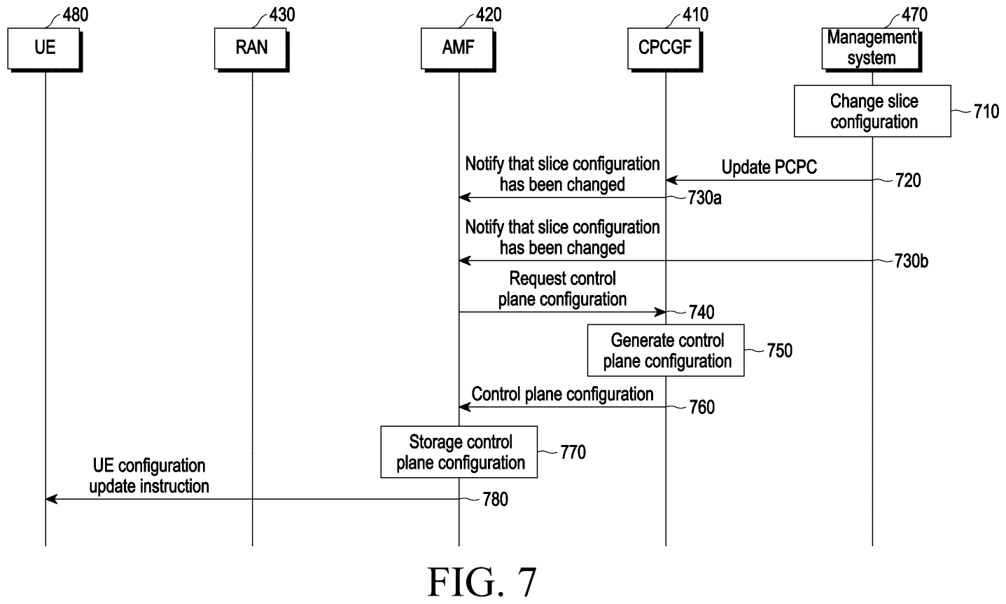

FIG. 7 is a flowchart illustrating operations of network entities for generating a control plane configuration, according to an embodiment.

A management system 470 may identify that a slice configuration has been changed (710). The management system 470 may also be referred to as an operator, a server, or a certain core network entity. The management system 470 may be a network slicing management system such as, but not limited to, an NSMF or an NSSMF.

The slice configuration may be changed by the management system 470. The change in the slice configuration may cause a change in PCPCs. Therefore, when the slice configuration is changed, an update of a PCPC may be required.

The management system 470 may transmit an update PCPC message to the CPCGF 410, based on identifying that the slice configuration has been changed (720).

The CPCGF 410 may update PCPCs for the UE 480, based on receiving the update PCPC message.

The CPCGF 410 may notify the AMF 420 that the PCPC has been changed (730a). Alternatively, the management system 470 may notify the AMF 420 that the PCPC has been changed (730b). The notification for the change in the PCPC may trigger the AMF 420 to update a CP configuration.

The AMF 420 may transmit a control plane configuration request to the CPCGF 410, based on receiving the notification that the PCPC has been changed (740).

The CPCGF 410 may generate a control plane configuration, based on receiving the control plane configuration request from the AMF 420 (750). The CPCGF 410 may perform matching of PCPCs to generate the control plane configuration, and determine a plurality of parameters for the control plane configuration, based on at least one PCPC identified through the matching. A method for generating a control plane configuration by the CPCGF 410 is described with reference to FIG. 10.

The CPCGF 410 may transmit the generated control plane configuration to the AMF 420 in response to the control plane configuration request (760).

When there are a plurality of UEs related to the change in the slice configuration, operations 740 to 760 may be performed repeatedly to generate (or update) a control plane configuration for each of the plurality of UEs.

The AMF 420 may store the received control plane configuration (770).

The AMF 420 may transmit a registration acceptance message to the UE 480 through the RAN 430 (780). The registration acceptance message may include the control plane configuration received from the CPCGF 410.

The UE 480 may store the control plane configuration included in the registration acceptance message.

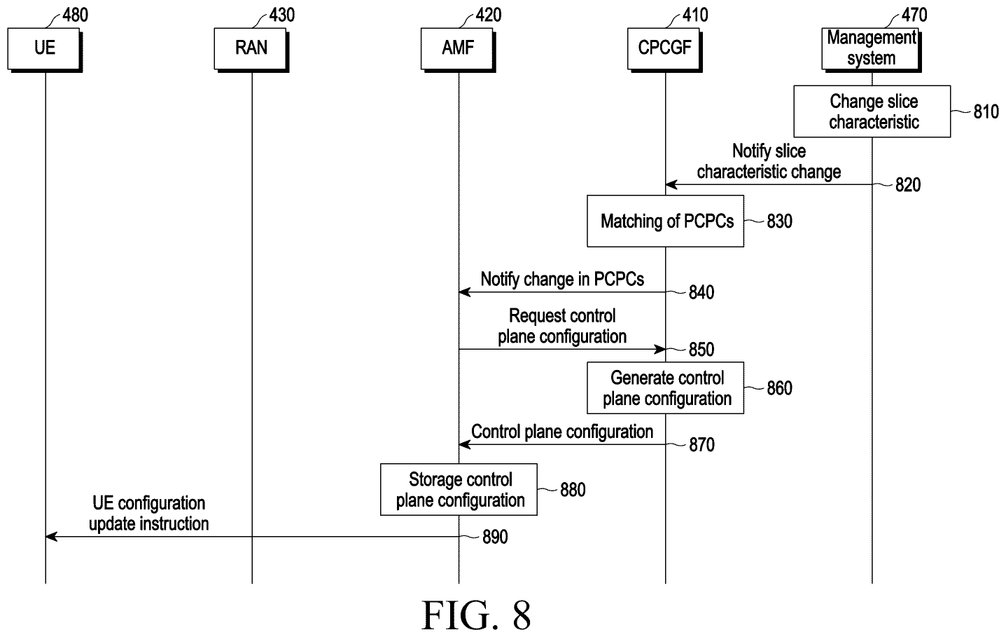

FIG. 8 is a flowchart illustrating operations of network entities for generating a control plane configuration, according to an embodiment.

The management system 470 may identify that a slice characteristic has been changed (810). When a network slice is modified and requirements for a control plane is changed, a UE configuration update may be performed to perform a slice characteristic change procedure. The slice characteristic change procedure assumes that PCPCs are matched based on slice characteristics. When the PCPCs are not modified but the network slice is modified, this may result in different slice characteristics.

The management system 470 may notify the CPCGF 410 of a slice characteristic change (820). A message for notifying the slice characteristic change may include a slice identification (ID) and new slice characteristics for the slice ID.

The CPCGF 410 may perform matching of PCPCs (830). Performing matching of PCPCs may include identifying at least one PCPC matching with information about a network slice for a UE. The information about the network slice for the UE used to perform the matching may include at least one of an NSI ID, an NSSI ID, an SST and/or an SD, a slice characteristic, a UE ID, and a UE group (or UE group ID).

The CPCGF 410 may notify the AMF 420 that the PCPCs have been changed (840).

The AMF 420 may request a control plane configuration from the CPCGF 410, based on receiving the notification for the change in the PCPCs (850).

The CPCGF 410 may generate the control plane configuration, based on receiving a control plane configuration request from the AMF 420 (860). The CPCGF 410 may determine a plurality of parameters for the control plane configuration, based on at least one PCPC identified through the matching. A method for generating a control plane configuration by the CPCGF 410 is described in detail later with reference to FIG. 10.

The CPCGF 410 may transmit the generated control plane configuration to the AMF 420 in response to the control plane configuration request (870).

The AMF 420 may store the received control plane configuration (880).

The AMF 420 may transmit a registration acceptance message to the UE 480 through the RAN 430 (880). The registration acceptance message may include the control plane configuration received from the CPCGF 410.

The UE 480 may store the control plane configuration included in the registration acceptance message.

Referring to FIGS. 5 to 8, embodiments in which the CPCGF 410 is configured as a network entity separate from the AMF 420 have been described. However, when the CPCGF 410 is configured in the AMF 420 as described in FIG. 4A, the operations of the

CPCGF 410 in FIGS. 5 to 8 may be executed by the AMF 420, and communications between the CPCGF 410 and the AMF 420 may be omitted.

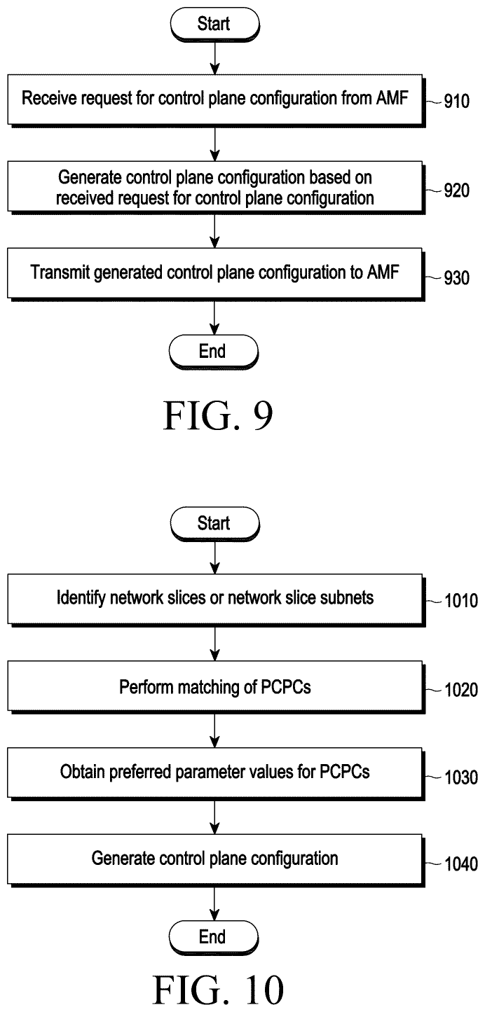

FIG. 9 is a flowchart illustrating operations of a CPCGF 410, according to an embodiment.

A CPCGF 410 may receive a request for a control plane configuration for a UE 480 from an AMF 420 (910).

The request for the control plane configuration may be received from the AMF 420 based on the AMF 420 receiving a registration request for the UE.

The request for the control plane configuration may be received from the AMF 420 based on the AMF 420 receiving a notification for a change in a network slice configuration. The AMF 420 may receive the notification for the change in the network slice configuration from the CPCGF 410 or a network slicing management system.

The request for the control plane configuration may be received from the AMF 420 based on the AMF 420 receiving a notification for a change in at least one PCPC from the CPCFG.

As in FIG. 4A, when the CPCGF 410 is configured within the AMF 420, operation 910 may be omitted.

The CPCGF 410 may generate the control plane configuration for the UE 480, based on the received request for the control plane configuration (920). The CPCGF 410 may perform matching of PCPCs to generate the control plane configuration, and determine a plurality of parameters for the control plane configuration, based on at least one PCPC identified through the matching.

Performing matching of PCPCs may include identifying at least one PCPC matching with information about a network slice for the UE 480. The information about the network slice for the UE 480 used to perform the matching may include at least one of an NSI ID, an NSSI ID, an SST and/or an SD, a slice characteristic, a UE ID, and a UE group (or UE group ID).

Each PCPC may include parameters for the control plane configuration, and the CPCGF 410 may generate the control plane configuration, based on the parameters included in the identified PCPCs. This is further described with reference to in operation 1030 of FIG. 10.

As in FIG. 4A, when the CPCGF 410 is configured within the AMF 420, the AMF 420 (or the CPCGF 410 configured within the AMF 420) may generate a control plane configuration, based on the AMF 420 receiving a registration request, receiving a notification for a change in a slice configuration, or receiving a notification for a change in a slice characteristic.

The CPCGF 410 may transmit the generated control plane configuration to the AMF 420 (930). When the CPCGF 410 is configured inside the AMF 420, the generated control plane configuration may be transmitted to other entities (e.g., a base station and a UE 480) through a registration acceptance message or a UE 480 configuration update instruction.

FIG. 10 is a flowchart illustrating operations of a CPCGF 410 for generating a control plane configuration, according to an embodiment.

The operations of FIG. 10 may be performed based on a CPCGF 410 receiving a request for a control plane configuration.

The request for the control plane configuration may include information received from a UE 480 in a registration request, a registration modification request, or current registration information, and may further include information available in an AMF 420. The request for the control plane configuration may include at least one of the following information.
Requested NSSAI (e.g., a list of S-NSSAI (e.g., SST+SD) of network slices to which the UE 480 requests to connect)
Allowed NSSAI (e.g., a list of S-NSSAI (e.g., SST+SD) of network slices to which the UE 480 is allowed to connect)
Currently connected NSSAI
Target NAASI
NSI ID
UE ID
UE group (or UE group ID)
Old and new tracking area or tracking area code
Default control plane configuration (e.g., a control plane configuration to be returned within a registration acceptance message when a CPCGF 410 does not exist)

When the CPCGF 410 is configured within the AMF as in FIG. 4A, the operations of FIG. 10 may be performed based on performing at least one of a registration request message, a notification for a change in a slice configuration, and a notification for a change in a slice characteristic.

When the CPCGF 410 is configured within a PCF as in FIG. 4B, the operations of FIG. 10 may be executed based on receiving an Npcf_AMPolicyControl_Create message or an Npcf_AMPolicyControl_Update message as described in section 5.2.5.2 of 3GPP TS 23.502.

The CPCGF 410 may identify network slices or network slice subnets (1010). Network slices or network slice subnets that the UE 480 requests to register or add to NSSAI may be identified. The CPCGF 410 may identify network slices or network slice subnets through one or more of the following.
By requested/allowed NSSAI (a list of SSTs and SDs of NSIs)
By NSI ID (if provided within the request)
By querying a network slicing management system for an NSI ID, a network slice subnet instance (NSSI) ID, or slice characteristics (a query may include at least one of an SST, an SD, and an NSI ID, and a response may include at least one of an NSI ID, an NSSI ID, and slice characteristics (including at least one of service profile or slice profile attributes, a network slice subnet type, and a priority label)

The NSSAI, including the list of SSTs and SDs, may be generally known to the AMF 420, and thus may be included and provided in the request for the control plane configuration.

The CPCGF 410 may perform matching of PCPCs (1020). That is, the CPCGF 410 may detect at least one PCPC matching with the NSSAI. The matching may be performed based on at least one of an NSI ID, an NSSI ID, an SST and/or an SD, a slice characteristic, and a UE identifier or a UE group identifier.

The CPCGF 410 may obtain preferred parameter values for the PCPCs (1030). The CPCGF 410 may execute this operation to obtain PCPC parameter values which require calculation of current network parameters. The CPCGF 410 may execute this operation when the PCPC includes procedures or formulas for deriving a preferred parameter based on a current state within a network. In other cases, this operation may be omitted.

The CPCGF 410 may generate the control plane configuration (1040). For each control plane parameter, matching PCPCs may include a value of a preferred parameter. Selection of a control plane configuration parameter may be performed through at least one of the following methods.
Select a value from a PCPC having the highest priority
Select a value from NSI having the highest priority or a PCPC associated with the NSI
Select the best value from PCPCs with which the best value matches, the best value being defined according to a comparison policy, such as, but not limited to, a predefined policy for the highest numerical value, the lowest numerical value, and a non-numerical value
Generate a value by using a PCPC or a procedure which uses a request parameter as an input
Select a value from a PCPC according to a predefined PCPC selection policy, such as, but not limited to, selecting a specific value from PCPC A when PCPC A, PCPC B, and PCPC C match.
Artificial intelligence (AI)/machine learning (ML) algorithm
Default value when no PCPC defines a preferred control plane parameter value

The CPCGF 410 may transmit the generated control plane configuration to another entity (e.g., the AMF 420). When the CPCGF 410 is configured inside the PCF, the generated control plane configuration may be transmitted to another entity through an Npcf_AMPolicyControl_Create response message or an Npcf_AMPolicyControl_Update message. When the CPCGF 410 is configured inside the AMF 420, the generated control plane configuration may be transmitted to other entities (e.g., a base station and a UE 480) through a registration acceptance message or a UE configuration update instruction.

Parameters for a control plane configuration may include, for example, at least one of the following.
Paging configuration in the AMF
   T-DRX (discontinuous reception) cycle: This defines a time between paging opportunities of the UE
   nB: This defines the number of possible paging opportunities per radio frame
   Paging policy through which area paging is transmitted
Mobility configuration in the RAN
   Radio access type/frequency of selection priority (RFSP) index-Refer to a specific radio resource management (RRM) policy defined in the RAN
UE control plane configuration
   Registration area
   Periodic registration update timer
   Active time
   Strictly periodic registration timer display
   Accepted mobile initiated connection only (MICO) mode
   IP multimedia subsystem (IMS) voice support indication through packet switched (PS) session (IMS Voice over PS session supported Indication)
   DRX parameters accepted for E-UTRA and NR
   DRX parameters accepted for NB-IOT
   Extended idle mode DRX parameters
   Paging time window
   Operator-defined access category definitions
   Improved coverage limitation information
   Supported network behavior
   Wake up signal (WUS) assistance information
   AMF paging early indication with paging subgrouping (PEIPS) assistance information
   Support for paging cause indication for voice service support (Paging Cause Indication for Voice Service Supported)
   Support for paging restriction (Paging Restriction Supported)
   Support for paging request rejection (Reject Paging Request Supported)
   Acceptance/rejection of paging restriction information

FIG. 11 is a block diagram of an apparatus, according to an embodiment.

An apparatus 1100 may be an apparatus for implementing one of the network entities described above (e.g., a CPCGF 410, an AMF 420, a PCF, a network slicing management system, a base station, or the like).

The apparatus 1100 may include a memory 1110, a transceiver 1120, and a controller 1130.

The memory 1110 may store at least one of information transmitted and/or received through the transceiver 1120, and information generated through the controller 1130. The memory 1110 may additionally store information/data/commands/instructions to be executed by the controller 1130 to cause the apparatus 1100 to perform the operations described herein. The memory 1110 may also be referred to as a non-transitory computer readable storage medium.

The transceiver 1120 may be used to transmit signals from the controller 1130 to other entities or receive signals from other entities. The transceiver 1120 may support communication through various radio access technologies (RATs), including, for example, long term evolution (LTE), wireless fidelity (Wi-Fi), orthogonal frequency division multiplexing (OFDM), code divisional multiple access (CDMA), and Bluetooth™, and RATs supported by the transceiver 1120 are not limited thereto.

The controller 1130 may control operations of other elements of the apparatus 1100. The operations of the apparatus 1100 may be understood as being substantially executed by the controller 1130. The controller 1130 may be implemented through at least one processor. The controller 1130 may execute instructions stored in the memory 1110 to perform the operations of the apparatus 1100 described herein.

Although specific embodiments have been described in the detailed description of the disclosure, it is to be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method by a core network entity in a wireless communication system, the method comprising:
receiving, from an access and mobility management function (AMF), a request for a control plane configuration for a user equipment (UE);
generating the control plane configuration for the UE based on the received request for the control plane configuration; and
transmitting, to the AMF, the generated control plane configuration.

2. The method of claim 1, wherein the generating of the control plane configuration comprises:
generating the control plane configuration for the UE based on information about a network slice associated with the UE.

3. The method of claim 2, wherein the request for the control plane configuration comprises the information about the network slice associated with the UE.

4. The method of claim 2, further comprising:
obtaining, from a network slicing management system, the information about the network slice associated with the UE.

5. The method of claim 2, wherein the information about the network slice associated with the UE comprises at least one of:
a network slice instance identification (NSI ID);
a network slice subnet instance ID (NSSI ID);
a slice/service type (SST) and slice differentiator (SD);
a slice characteristic;
a UE ID; and
a UE group.

6. The method of claim 2, wherein the generating of the control plane configuration comprises:
identifying at least one preferred control plane configuration (PCPC) matched with the information about the network slice associated with the UE; and
determining a value of each of at least one parameter for the control plane configuration based on the at least one PCPC.

7. The method of claim 6, wherein the determining of the value of each of the at least one parameter for the control plane configuration comprises at least one of:
obtaining the value from a PCPC having a highest priority from among the at least one PCPC;
obtaining the value from a PCPC associated with at least one of a network slice instance (NSI) or a network slice subnet instance (NSSI) with a highest priority from among the at least one PCPC;
obtaining the value from a PCPC comprising a matching value according to a predetermined policy;
obtaining the value according to a PCPC policy;
obtaining the value using at least one of an artificial intelligence (AI) or a machine learning (ML) algorithm; and
determining a default value as the value, based on the at least one PCPC not defining the value for the at least one parameter.

8. The method of claim 1, wherein the receiving of the request for the control plane configuration comprises:
receiving, from the AMF, the request for the control plane configuration for the UE, based on the AMF having received a registration request for the UE.

9. The method of claim 8, wherein the registration request comprises a requested network slice selection assistant information (NSSAI).

10. The method of claim 1, wherein the receiving of the request for the control plane configuration comprises:
receiving, from the AMF, the request for the control plane configuration for the UE, based on the AMF having received a notification about a change in a network slice configuration.

11. The method of claim 10, wherein the notification about the change in the network slice configuration is received from at least one of the core network entity or a network slicing management system.

12. The method of claim 1, further comprising:
receiving a notification for a change of a network slice characteristic;
performing matching of PCPCs based on receiving the notification for the change of the network slice characteristic; and
transmitting, to the AMF, a notification for a change of at least one PCPC based on the matching of the PCPCs.

13. The method of claim 12, wherein the receiving of the request for the control plane configuration comprises:
receiving, from the AMF, the request for the control plane configuration for the UE, based on the AMF receiving the notification for the change of the at least one PCPC.

14. An apparatus of a core network entity in a wireless communication system, the apparatus comprising:
at least one processor; and
memory storing instructions that, when executed by the at least one processor individually or collectively, cause the apparatus to:
receive, from an access and mobility management function (AMF), a request for a control plane configuration for a user equipment (UE);
generate the control plane configuration for the UE based on the received request for the control plane configuration; and
transmit, to the AMF, the generated control plane configuration to the AMF.

15. The apparatus of claim 14, wherein the instructions that, when executed by the at least one processor individually or collectively, cause the apparatus to:
generate the control plane configuration based on information about a network slice associated with the UE, and
wherein the request for the control plane configuration comprises the information about the network slice associated with the UE.

16. The apparatus of claim 15, wherein the instructions that, when executed by the at least one processor individually or collectively, cause the apparatus to:
obtain, from a network slicing management system, the information about the network slice associated with the UE.

17. The apparatus of claim 15, wherein the instructions that, when executed by the at least one processor individually or collectively, cause the apparatus to:
identify at least one preferred control plane configuration (PCPC) matched with the information about the network slice associated with the UE; and
determine a value of each of at least one parameter for the control plane configuration based on the at least one PCPC.

18. The apparatus of claim 17, wherein the instructions that, when executed by the at least one processor individually or collectively, cause the apparatus to perform at least one of:
obtaining the value from a PCPC having a highest priority from among the at least one PCPC;
obtaining the value from a PCPC associated with a network slice instance (NSI) or network slice subnet instance (NSSI) with a highest priority from among the at least one PCPC;
obtaining the value from a PCPC comprising a matching value according to a predetermined policy;
obtaining the value according to a PCPC policy;
obtaining the value using at least one of an artificial intelligence (AI) or a machine learning (ML) algorithm; and
determining a default value as the value, based on the at least one PCPC not defining the value for the at least one parameter.

19. The apparatus of claim 14, wherein the instructions that, when executed by the at least one processor individually or collectively, cause the apparatus to:
receive a notification for a change of a network slice characteristic;
perform matching of PCPCs based on receiving the notification for the change of the network slice characteristic; and
transmit, to the AMF, a notification for a change of at least one PCPC based on the matching of the PCPCs.

20. A non-transitory computer readable storage medium storing computer-executable instructions which, when executed by at least one processor of an apparatus of a core network entity in a wireless communication system, cause the apparatus to:
receive, from an access and mobility management function (AMF), a request for a control plane configuration for a user equipment (UE);
generate the control plane configuration for the UE based on the received request for the control plane configuration; and
transmit, to the AMF, the generated control plane configuration.
